(19) United States
(12) Patent Application Publication
(10) Pub. No.: US 2025/0388794 A1
(43) Pub. Date: Dec. 25, 2025

(54) ANTI-ICING MAGNETIC FLUID MATERIAL FOR A CONDUCTOR AND PREPARATION METHOD THEREOF

(71) Applicant: Chongqing University, Chongqing (CN)

(72) Inventors: Yuan Yuan, Chongqing (CN); Xu Dai, Chongqing (CN); Ruijin Liao, Chongqing (CN)

(21) Appl. No.: 19/244,761

(22) Filed: Jun. 20, 2025

(30) Foreign Application Priority Data
Jun. 24, 2024 (CN) 202410822296.9

(51) Int. Cl. C09K 3/18; H01F 1/34

(52) U.S. Cl. CPC C09K 3/18; H01F 1/344

(57) ABSTRACT

The present invention relates to the technical field of anti-icing materials, and in particular to an anti-icing magnetic fluid material for a conductor and preparation method thereof. The magnetic fluid material provided by the present invention is a manganese-zinc ferrite nanoparticle, wherein the molecular formula of the manganese-zinc ferrite nanoparticle is (MnₓZn_{y}) Fe₂O₄. The manganese-zinc ferrite nanoparticle is prepared from the following materials, comprising, in parts by weight: 10-40 parts of ferric nitrate, 1-10 parts of manganese nitrate, and 1-15 parts of zinc nitrate. The manganese-zinc ferrite nanoparticle provided by the present invention can be used for the preparation of a magnetic fluid coating for anti-icing or anti-frosting of a power transmission conductor.

### TECHNICAL FIELD

The present invention relates to the technical field of anti-icing materials, and in particular to an anti-acing magnetic fluid material for a conductor and preparation method thereof.

### BACKGROUND

Ice accretion on power transmission lines poses a significant threat to the operational safety of electrical power systems. China is among the countries most severely affected by such icing events on power lines. At present, commonly used methods for preventing or mitigating icing on power lines include mechanical methods, natural passive methods, surface modifications of conductors, and thermal methods. Mechanical methods can only partially alleviate the icing events and do not effectively prevent them. Natural passive methods may result in conductor galloping and line faults due to uneven or asynchronous ice shedding. Surface modification methods are generally ineffective against glaze ice. Thermal de-icing methods rely on either external heat sources or the self-heating capability of the conductor to prevent the accumulation of ice and snow or to melt already accumulated ice. Studies have shown that magnetic fluids (also referred to as magnetic liquids), as novel functional materials, possess both the fluidity of liquids and the magnetic properties of solid magnetic materials, theoretically making them suitable for anti-icing applications on conductors. However, in power transmission lines, the continuous presence of alternating current generates strong magnetic fields. If the magnetic fluid remains in a protruding state on the conductor surface during operation, it may exacerbate corona discharge, thereby introducing potential defects. Moreover, if the heat generated by the magnetic materials is not properly controlled, they may act as unintended heat sources, thereby posing safety risks due to conductor overheating.

Currently, there are relatively few reports concerning the use of magnetic fluid materials for anti-icing purposes. Existing patents primarily focus on the application of magnetic fluids in aircraft anti-icing, such as Chinese Patents CN110774709A and CN111806701A. For instance, the Chinese Patent CN111806701A (published on Oct. 23, 2020) discloses a magnetically sensitive porous anti-icing composite material, in which commercial Fe₃O₄ nanoparticles with a particle size of 800 nm, polydimethylsiloxane, toluene, and silicone oil are mixed and cured, and coated into anodized pores, achieving good anti-icing performance. However, the core loss characteristics of this material are not clearly defined, and its application on power transmission lines may raise safety concerns.

In summary, there is an urgent need for a novel method or material to alleviate the deficiencies of the prior art.

### SUMMARY

In view of this, the objective of the present invention is to provide an anti- icing magnetic fluid material for a conductor and preparation method thereof. The specific technical solutions are provided as follows.

A manganese-zinc ferrite nanoparticle, wherein the molecular formula of the manganese-zinc ferrite nanoparticle is (MnₓZn_{y}) Fe₂O₄, wherein X=0.1-1 and Y=0.1-1; the manganese-zinc ferrite nanoparticle is prepared from the following materials, comprising, in parts by weight: 10-40 parts of ferric nitrate, 1-10 parts of manganese nitrate, and 1-15 parts of zinc nitrate.

Further, X=0.1, 0.2, 0.3, 0.4, 0.5, 0.6, 0.7, 0.8, 0.9, or 1; and Y=0.1, 0.2, 0.3, 0.4, 0.5, 0.6, 0.7, 0.8, 0.9, or 1.

Further, the manganese-zinc ferrite nanoparticle is prepared from the following materials, comprising, in parts by weight: 30-40 parts of ferric nitrate, 5-10 parts of manganese nitrate, and 10-15 parts of zinc nitrate.

In a preferred embodiment, the manganese-zinc ferrite nanoparticle is prepared from the following materials, comprising, in parts by weight: 40 parts of ferric nitrate, 10 parts of manganese nitrate, and 10 parts of zinc nitrate.

In a preferred embodiment, the molecular formula of the manganese-zinc ferrite nanoparticle is (MnₓZn_{y}) Fe₂O₄, wherein X=0.5 and Y=0.5.

Further, a particle size of the manganese-zinc ferrite nanoparticle is in the range of approximately 100-200 nm.

In a preferred embodiment, a particle size of the manganese-zinc ferrite nanoparticle is in the range of approximately 100-150 nm.

Further, the range of the particle size of the manganese-zinc ferrite nanoparticle comprises 100-110 nm, 110-120 nm, 120-130 nm, 130-140 nm, or 140-150 nm.

A preparation method for the above-mentioned manganese-zinc ferrite nanoparticle, wherein the preparation method is a hydrothermal method, comprising the following steps:
S01: adding the following materials in parts by weight into purified water and stirring to obtain a reaction solution: 10-40 parts of ferric nitrate, 1-10 parts of manganese nitrate, and 1-15 parts of zinc nitrate; and adjusting pH of the reaction solution to be alkaline;
S02: transferring the reaction solution into a hydrothermal reactor and performing a hydrothermal reaction at a temperature of 100˜300° C. for 6˜48 hours to obtain a first product;
S03: centrifuging the first product, followed by drying, grinding, and annealing to obtain a crude manganese-zinc ferrite nanoparticle product; a method of the annealing comprises heating at a rate of 3-10° C./min to a temperature of 600- 1200° C., maintaining the temperature of 600-1200° C. for 4-24 hours, and then cooling to room temperature;
S04: modifying the crude manganese-zinc ferrite nanoparticle product with a 5-25 wt. % oleic acid solution followed by a 3-20 wt. % fluorosilane solution in ethanol, to obtain a modified manganese-zinc ferrite nanoparticle.

Further, the pH of the reaction solution in the S01 is adjusted to a range of 9-11.

Further, the hydrothermal reaction in the S02 is performed at a temperature of 120-180° C. for 12-18 hours in the hydrothermal reactor.

Further, the method of the annealing in the S03 is heating at a rate of 5-10° C./min to a temperature of 900-1000° C., maintaining the temperature of 900-1000° C. for 12-24 hours, and then cooling to room temperature.

Further, subjecting the crude manganese-zinc ferrite nanoparticle product to ultrasonic treatment in methanol to obtain a second product, adding the second product to a 5-25 wt. % oleic acid solution, a 3-20 wt. % fluorosilane solution in ethanol, or a 5-25 wt. % oleic acid solution followed by a 3-20 wt. % fluorosilane solution in ethanol to obtain a mixture; heating the mixture to remove an unreacted solvent and obtain a third product; and then washing, drying, and collecting the third product via magnetic separation (to confirm the magnetic properties of the nanoparticle obtained) to obtain the modified manganese-zinc ferrite nanoparticle in the S04.

In a preferred embodiment, the crude manganese-zinc ferrite nanoparticle product is co-modified with a 5-25 wt. % oleic acid solution followed by a 3-20 wt. % fluorosilane solution in the S04.

The modification with oleic acid or fluorosilane introduces active functional groups or imparts hydrophobic properties to the surface of the manganese-zinc ferrite nanoparticle, thereby enhancing its compatibility with subsequent oil-based solvents such as silicone oil, and enabling the formation of a uniform magnetic fluid.

An application of the above-mentioned manganese-zinc ferrite nanoparticle in the preparation of an anti-icing magnetic fluid coating or an anti-frosting magnetic fluid coating for a power transmission conductor.

Further, the manganese-zinc ferrite nanoparticle is mixed uniformly with an oil-based solvent such as silicone and subjected to ultrasonic treatment to prepare a magnetic fluid coating.

Further, the magnetic fluid coating may be filled into a porous surface structure of a power transmission conductor under the influence of an externally applied magnetic field generated by a magnet.

### Beneficial Effects

The present invention utilizes a hydrothermal method to prepare a manganese-zinc ferrite nanoparticle with a particle size of approximately 100 nm and a tetragonal crystal structure. The manganese-zinc ferrite nanoparticle exhibits a low Curie temperature and minimal core loss, making it suitable for the preparation of anti-icing and anti-frosting materials for power transmission conductors.

Furthermore, the manganese-zinc ferrite nanoparticle prepared in the present invention is modified with oleic acid, fluorosilane, or oleic acid and fluorosilane. Such modification introduces active functional groups or imparts hydrophobic properties to the surface of the manganese-zinc ferrite nanoparticle, thereby enhancing its compatibility with subsequent oil-based solvents such as silicone oil, and enabling the formation of a uniform magnetic fluid material (also referred to as a magnetic fluid coating). The manganese-zinc ferrite nanoparticle may be coated within a superhydrophobic oxidized porous structure resistant to low temperatures and high humidity, thereby imparting excellent anti-icing and anti-frosting properties to power transmission conductors.

Finally, the hydrothermal method utilized in the present invention features operational simplicity, low equipment requirements, and controllable overall cost, making it suitable for large-scale industrial production.

As used herein, the term “modifying . . . with a 5-25 wt. % oleic acid solution” or any variant thereof refers to adding the crude manganese-zinc ferrite nanoparticle product to a 5-25 wt. % oleic acid solution. As used herein, the term “modifying . . . with a 3-20 wt. % fluorosilane solution in ethanol” or any variant thereof refers to adding the crude manganese-zinc ferrite nanoparticle product to a 3-20 wt. % fluorosilane solution in ethanol. As used herein, the term “modifying. with a 5-25 wt. % oleic acid solution followed by a 3-20 wt. % fluorosilane solution in ethanol” or any variant thereof refers to a two-step modification process in which the crude manganese-zinc ferrite nanoparticle product is first subjected to a first modification by being added to the 5-25 wt. % oleic acid solution, and the resulting first-modified product is then subjected to a second modification by being added to the 3-20 wt. % fluorosilane solution in ethanol.

### BRIEF DESCRIPTION OF DRAWINGS

To make the embodiments of the present invention or the technical solutions in the prior art clearer, the drawings required to be used in the description of the embodiments or the prior art will be briefly introduced below. In all the drawings, similar elements or parts are generally identified by similar reference numerals. The elements or parts in the drawings are not necessarily drawn to scale. It is obvious that the drawings described below are some embodiments of the present invention, and that other drawings can be obtained from these drawings for those of ordinary skill in the art without making inventive effort.

FIG. 1 shows the manganese-zinc ferrite nanoparticle prepared in one embodiment of the present invention.

FIG. 2 is a scanning electron microscope image of the material prepared via a water bath reaction at 60° C. for 12 hours in one embodiment of the present invention.

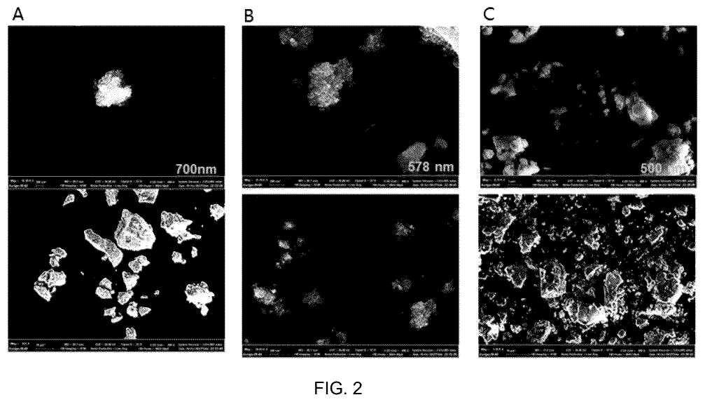

FIG. 3 is a scanning electron microscope image of the material prepared via a water bath reaction at 80° C. for 12 hours in one embodiment of the present invention.

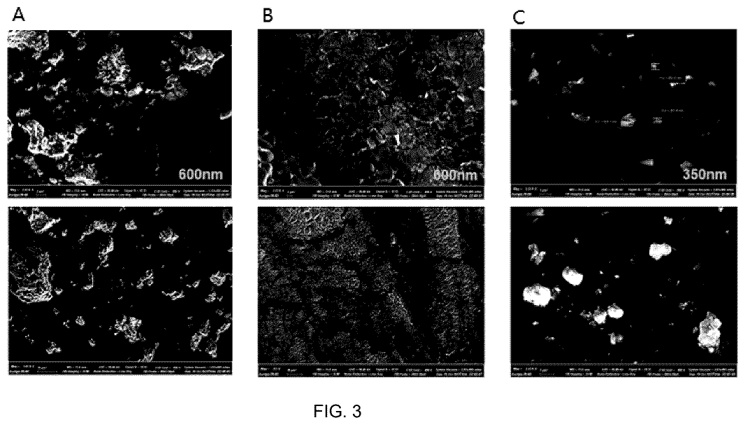

FIG. 4 is a scanning electron microscope image of the material prepared via a water bath reaction at 120° C. for 12 hours in one embodiment of the present invention.

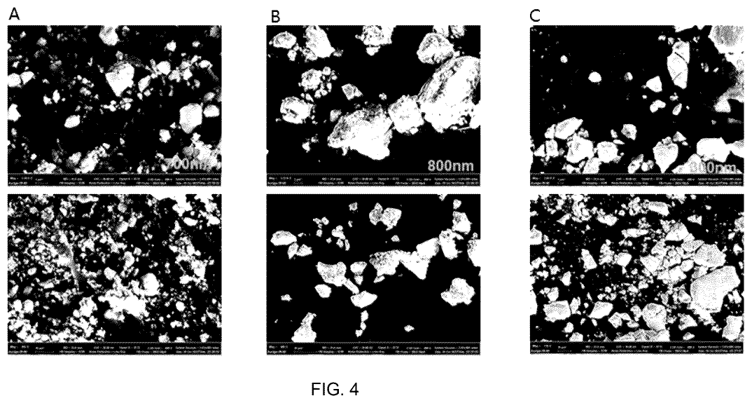

FIG. 5 is a scanning electron microscope image of the material prepared via a water bath reaction at 180° C. for 12 hours in one embodiment of the present invention.

FIG. 6 shows an anti-frosting oxidized porous structure resistant to low temperatures and high humidity prepared in one embodiment of the present invention (scale bar=1 μm).

FIG. 7 shows the Curie temperature of the manganese-zinc ferrite nanoparticle prepared in one embodiment of the present invention.

FIG. 8 is a thermogravimetric analysis diagram of the manganese-zinc ferrite nanoparticle prepared in one embodiment of the present invention.

FIGS. 9A and 9B show the anti-frosting and anti-icing performance test results of the manganese-zinc ferrite nanoparticle in one embodiment of the present invention, where FIG. 9A represents the experimental sample and FIG. 9B represents the control sample.

FIG. 10 shows the core loss test results of the manganese-zinc ferrite nanoparticle in one embodiment of the present invention.

### DETAILED DESCRIPTION

To make the objective, the technical solutions and advantages of the embodiments of the present invention clearer, the technical solutions of the embodiments of the present invention will be clearly and completely described below in combination with drawings. It is obvious that the described embodiments are some of the embodiments of the present invention, not all of the embodiments. Based on the embodiments of the present invention, all other embodiments obtained by those of ordinary skill in the art without making inventive effort shall belong to the protection scope of the present invention.

As used herein, “and/or” includes any and all combinations of one or more of the items listed.

As used herein, “multiple” means two or more, i.e., it includes two, three, four, five, etc.

It should be noted that the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s) unless further defined.

As used herein, the term “about”, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

### Embodiment 1

This embodiment provides an exemplary preparation method for a manganese-zinc ferrite nanoparticle.

### Preparation Method:

S01: adding the following materials in parts by weight into purified water and stirring to obtain a reaction solution: 40 parts of ferric nitrate, 10 parts of manganese nitrate, and 10 parts of zinc nitrate; and adjusting pH of the reaction solution to 10.

S02: transferring the reaction solution into a hydrothermal reactor and performing a hydrothermal reaction at 180° C. for 12 hours to obtain a first product.

S03: Centrifuging the first product and washing it with ethanol three times, followed by drying, grinding, and annealing to obtain a crude manganese-zinc ferrite nanoparticle product. Specifically, the method of the centrifugation is at 8500 rpm for 5 minutes. The annealing method comprises placing the powder in a crucible and heating it in a muffle furnace at a rate of 5° C./min to a temperature of 900-1000° C., maintaining the temperature of 900-1000° C. for 12-24 hours, and cooling to room temperature.

S04: subjecting the crude manganese-zinc ferrite nanoparticle product to ultrasonic treatment in methanol to obtain a second product, adding the second product to 5-25 wt. % oleic acid (OA) solution to obtain a mixture; heating the mixture to 60-90° C. to remove an unreacted solvent (such as methanol) and obtain a third product; after filtering out excess oleic acid, washing the nanoparticles (the third product) with methanol or ethanol, and collecting them via magnetic separation to obtain an oleic acid-modified manganese-zinc ferrite nanoparticle. Alternatively, subjecting the crude manganese-zinc ferrite nanoparticle product to ultrasonic treatment in methanol to obtain a second product, adding the second product to 3-20 wt. % fluorosilane (FAS) solution in ethanol to obtain a mixture; heating the mixture to 60-90° C. to remove an unreacted solvent (such as methanol) and obtain a third product; washing the nanoparticles (the third product) and collecting them via magnetic separation to obtain a fluorosilane-modified manganese-zinc ferrite nanoparticle. Alternatively, subjecting the crude manganese-zinc ferrite nanoparticle product to ultrasonic treatment in methanol to obtain a second product, adding the second product to 5-25 wt. % oleic acid (OA) solution followed by 3-20 wt. % fluorosilane (FAS) solution (i.e. co-modifying the second product with 5-25 wt. % oleic acid (OA) solution followed by 3-20 wt. % fluorosilane (FAS) solution) to obtain a mixture; heating the mixture to 60-90° C. to remove an unreacted solvent (such as methanol) and obtain a third product; after the co-modification, washing the nanoparticles (the third product) and collecting them via magnetic separation to obtain an OA+FAS co-modified manganese-zinc ferrite nanoparticle.

It should be understood that modification with oleic acid introduces organic functional groups on the surface of the manganese-zinc ferrite nanoparticle. Modification with fluorosilane imparts—CF groups to the surface of the manganese-zinc ferrite nanoparticle, improving its hydrophobicity and thereby enhancing its anti-icing and anti-frosting performance.

### Control 1—Without Annealing Treatment: S01-S02

S01: adding the following materials in parts by weight into purified water and stirring to obtain a reaction solution: 40 parts of ferric nitrate, 10 parts of manganese nitrate, and 10 parts of zinc nitrate; and adjusting pH of the reaction solution to 10.

S02: transferring the reaction solution into a hydrothermal reactor and performing a hydrothermal reaction at 180° C. for 12 hours. Centrifuging the resulting solution and washing it with ethanol three times, followed by drying and grinding to obtain a crude manganese-zinc ferrite nanoparticle product. Specifically, the method of the centrifugation is at 8500 rpm for 5 minutes.

### Control 2—Annealing Without Modification Treatment: S01-S03

S01: adding the following materials in parts by weight into purified water and stirring to obtain a reaction solution: 40 parts of ferric nitrate, 10 parts of manganese nitrate, and 10 parts of zinc nitrate; and adjusting pH of the reaction solution to 10.

S02: transferring the reaction solution into a hydrothermal reactor and performing a hydrothermal reaction at 180° C. for 12 hours.

S03: Centrifuging the resulting solution and washing it with ethanol three times, followed by drying, grinding, and annealing to obtain a crude manganese-zinc ferrite nanoparticle product. Specifically, the method of the centrifugation is at 8500 rpm for 5 minutes. The annealing method comprises placing the powder in a crucible and heating it in a muffle furnace at a rate of 5° C./min to a temperature of 900-1000° C., maintaining the temperature of 900-1000° C. for 12-24 hours, and cooling to room temperature.

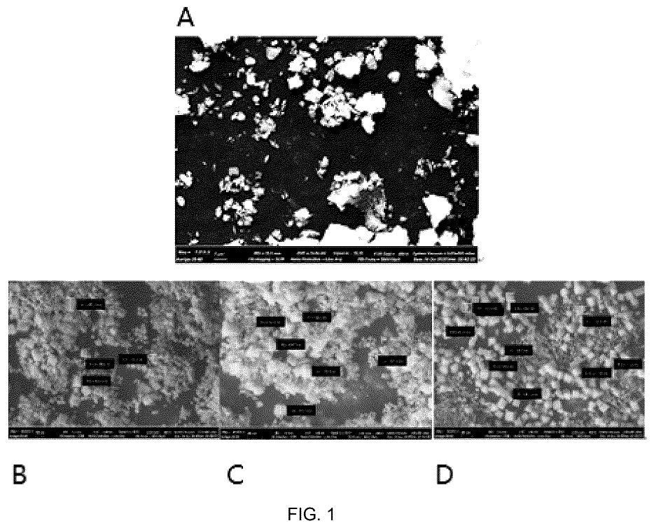

The molecular formula of the manganese-zinc ferrite nanoparticle prepared in this embodiment is (Mn_{0.5}Zn_{0.5}) Fe₂O₄. The scanning electron microscope image is shown in FIG. 1, where: A represents unannealed nanoparticles (scale bar: 2 μm); B represents annealed but unmodified nanoparticles (scale bar: 100 nm); C represents annealed and OA-modified nanoparticles (scale bar: 200 nm); and D represents annealed and OA+FAS co-modified nanoparticles (scale bar: 200 nm). The OA− or OA+FAS-modified nanoparticles exhibit particle sizes in the range of approximately 100-150 nm and show complete crystal morphology, generally with a tetragonal shape.

### Embodiment 2

This embodiment provides another exemplary preparation method.

(1) By adjusting the parameters of the hydrothermal reaction and material ratios, nanoparticles with different crystal morphologies are obtained.

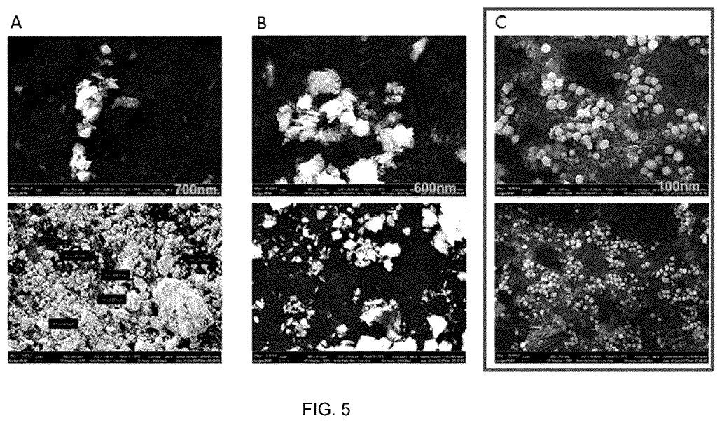

TABLE 1

| | | Hydrothermal | | |
|---|---|---|---|---|
| | Material Ratio | Reaction | | |
| Molecular Formula | (by weight) | Conditions | Morphology | Particle Size |
| (Mn_{0.3}Zn_{0.7})Fe₂O₄ | 40 parts of | Water bath at | No crystal | Approximately |
| | ferric nitrate, 6 | 60° C. for 12 h | morphology (FIG. | 700 nm |
| | parts of | | 2A, scale bar: | |
| | manganese | | 200 nm/10 μm) | |
| | nitrate, 14 parts | | | |
| | of zinc nitrate | | | |
| (Mn_{0.4}Zn_{0.6})Fe₂O₄ | 40 parts of | Water bath at | No crystal | Approximately |
| | ferric nitrate, 8 | 60° C. for 12 h | morphology (FIG. | 578 nm |
| | parts of | | 2B, scale bar: | |
| | manganese | | 200 nm/200 nm) | |
| | nitrate, 12 parts | | | |
| | of zinc nitrate | | | |
| (Mn_{0.5}Zn_{0.5})Fe₂O₄ | 40 parts of | Water bath at | No crystal | Approximately |
| | ferric nitrate, 10 | 60° C. for 12 h | morphology (FIG. | 500 nm |
| | parts of | | 2C, scale bar: | |
| | manganese | | 1 μm/10 μm) | |
| | nitrate, 10 parts | | | |
| | of zinc nitrate | | | |
| (Mn_{0.3}Zn_{0.7})Fe₂O₄ | 40 parts of | Water bath at | No crystal | Approximately |
| | ferric nitrate, 6 | 80° C. for 12 h | morphology (FIG. | 600 nm |
| | parts of | | 3A, scale bar: | |
| | manganese | | 2 μm/10 μm) | |
| | nitrate, 14 parts | | | |
| | of zinc nitrate | | | |
| (Mn_{0.4}Zn_{0.6})Fe₂O₄ | 40 parts of | Water bath at | No crystal | approximately |
| | ferric nitrate, 8 | 80° C. for 12 h | morphology (FIG. | 600 nm |
| | parts of | | 3B, scale bar: | |
| | manganese | | 1 μm/20 μm) | |
| | nitrate, 12 parts | | | |
| | of zinc nitrate | | | |
| (Mn_{0.5}Zn_{0.5})Fe₂O₄ | 40 parts of | Water bath | No crystal | Approximately |
| | ferric nitrate, 10 | 80° C. for 12 h | morphology (FIG. | 350 nm |
| | parts of | | 3C, scale bar: | |
| | manganese | | 1 μm/2 μm) | |
| | nitrate, 10 parts | | | |
| | of zinc nitrate | | | |
| (Mn_{0.3}Zn_{0.7})Fe₂O₄ | 40 parts of | Water bath at | No crystal | Approximately |
| | ferric nitrate, 6 | 120° C. for | morphology (FIG. | 700 nm |
| | parts of | 12 h | 4A, scale bar: | |
| | manganese | | 1 μm/10 μm) | |
| | nitrate, 14 parts | | | |
| | of zinc nitrate | | | |
| (Mn_{0.4}Zn_{0.6})Fe₂O₄ | 40 parts of | Water bath at | No crystal | Approximately |
| | ferric nitrate, 8 | 120° C. for | morphology (FIG. | 800 nm |
| | parts of | 12 h | 4B, scale bar: | |
| | manganese | | 2 μm/20 μm) | |
| | nitrate, 12 parts | | | |
| | of zinc nitrate | | | |
| (Mn_{0.5}Zn_{0.5})Fe₂O₄ | 40 parts of | Water bath | No crystal | Approximately |
| | ferric nitrate, 10 | 120° C. for | morphology (FIG. | 300 nm |
| | parts of | 12 h | 4C, scale bar: | |
| | manganese | | 1 μm/10 μm) | |
| | nitrate, 10 parts | | | |
| | of zinc nitrate | | | |
| (Mn_{0.3}Zn_{0.7})Fe₂O₄ | 40 parts of | Water bath at | Well-crystallized | Approximately |
| | ferric nitrate, 6 | 180° C. for | tetragonal | 700 nm |
| | parts of | 12 h | structure (FIG. 5A, | |
| | manganese | | scale bar: | |
| | nitrate, 14 parts | | 1 μm/2 μm) | |
| | of zinc nitrate | | | |
| (Mn_{0.4}Zn_{0.6})Fe₂O₄ | 40 parts of | Water bath at | Well-crystallized | Approximately |
| | ferric nitrate, 8 | 180° C. for | tetragonal | 600 nm |
| | parts of | 12 h | structure (FIG. 5B, | |
| | manganese | | scale bar: | |
| | nitrate, 12 parts | | 1 μm/2 μm) | |
| | of zinc nitrate | | | |
| (Mn_{0.5}Zn_{0.5})Fe₂O₄ | 40 parts of | Water bath at | Well-crystallized | Approximately |
| | ferric nitrate, 10 | 180° C. for | tetragonal | 100 nm |
| | parts of | 12 h | structure (FIG. 5C, | |
| | manganese | | scale bar: | |
| | nitrate, 10 parts | | 200 nm/2 μm) | |
| | of zinc nitrate | | | |

### Embodiment 3

This embodiment provides an oxidized porous structure to contain a manganese-zinc ferrite magnetic fluid material.

Method: An aluminum sheet is pretreated (acid washing, alkaline washing, and rinsing), and then anodized in phosphoric acid electrolyte solution (3 mol/L) under constant voltage at 120 V for 20 minutes at room temperature. The anodized sheet is washed and dried. It is then soaked in a fluorosilane ethanol solution (3 wt. %) for 4 hours and cured by drying at 120° C., resulting in an oxidized porous structure that simulates a transmission conductor.

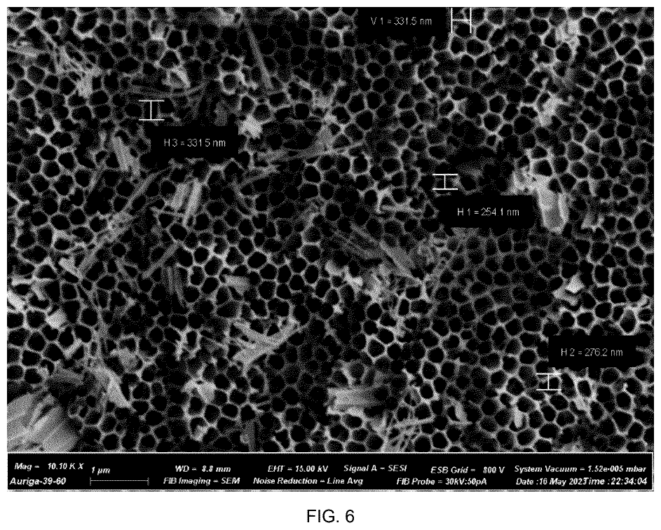

As shown in FIG. 6, the oxidized porous structure clearly exhibits pore diameters in the range of approximately 250 to 350 nm, confirming that the manganese-zinc ferrite nanoparticle prepared in Embodiment 1 can fully enter the pores. It is understood that the modified manganese-zinc ferrite nanoparticle may be uniformly mixed with an oil-based solvent such as silicone oil to prepare a magnetic fluid which can be filled into the oxidized porous structure for anti-icing or anti-frosting purposes.

### Embodiment 4

This embodiment provides performance validation of the manganese-zinc ferrite nanoparticle.

### 4.1 Curie Temperature

Method: A SQUID-VSM magnetic property measurement system (Quantum Design, USA) is used. The system is based on Superconducting Quantum Interference Device (SQUID) detection technology. By applying DC or AC magnetic fields to the magnetic material, it generates DC (AC) magnetization intensity versus temperature (field strength) curves for the test sample, namely the M-H and M-T curves. A linear fit is performed on the M-T curve, and the temperature point corresponding to the point of maximum slope is identified as the Curie temperature point. The procedure is as follows:
(1) Weigh the mass of the magnetic powder sample.
(2) Load the magnetic powder sample into the sample rod and place the sample rod into the measurement chamber.
(3) Flush the chamber with helium gas (default procedure: flush three times), followed by evacuation.
(4) Set the temperature range (100 K-400 K) and the magnetic field strength (1.5 T); scan the “signal-position” curve to locate the sample.
(5) Apply a DC or AC magnetic field to the magnetic powder sample to obtain DC (AC) magnetization intensity versus temperature (field strength) curves for the test sample, namely the M-T curves. A linear fit is performed on the M-T curve, and the temperature point of maximum slope is identified as the Curie temperature point.

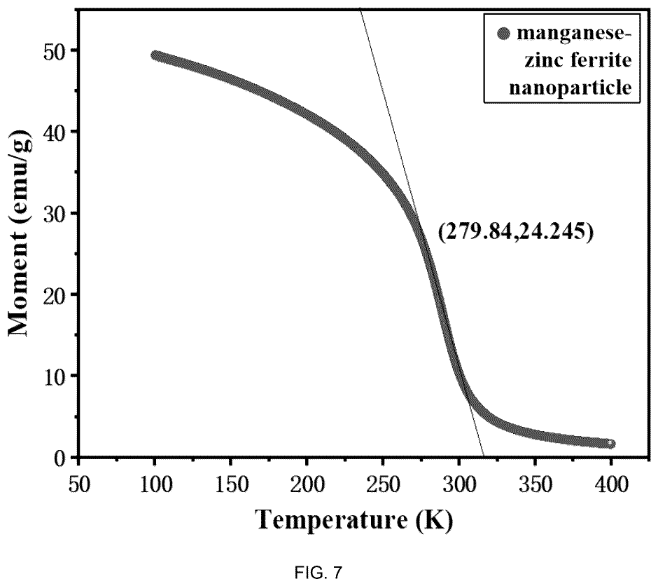

The manganese-zinc ferrite nanoparticle sample (molecular formula: (Mn_{0.5}Zn_{0.5}) Fe₂O₄), prepared and co-modified with oleic acid (OA) and fluorosilane (FAS) as described in Embodiment 1, undergoes M-T curve testing. As shown in FIG. 7, the Curie temperature is approximately 279.84 K, corresponding to a low-temperature state (approximately 6° C.).

### 4.2 Thermogravimetric Analysis (TGA)

Method: Thermogravimetric analysis is performed using a TGA analyzer. Under programmed temperature increase (from 0° C. to 1200° C., over the course of one hour), the mass change of the magnetic powder is measured as a function of temperature or time, and corresponding thermal absorption and release are recorded.

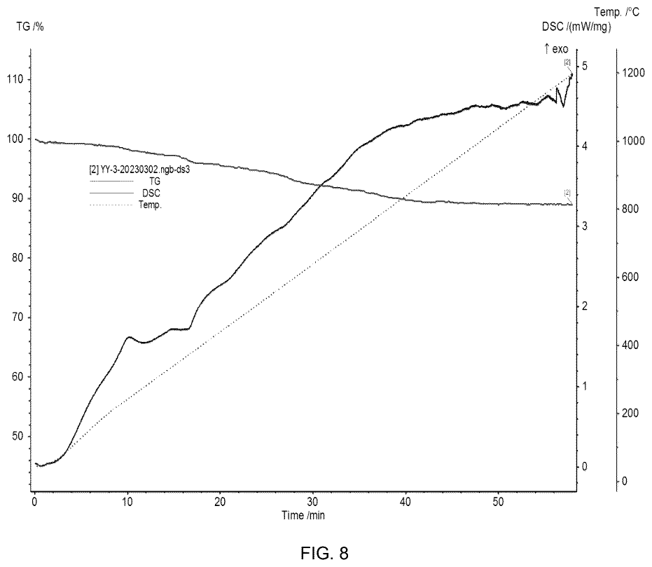

Thermogravimetric analysis is performed on the manganese-zinc ferrite nanoparticle sample prepared in Embodiment 1, as shown in FIG. 8. The results demonstrate that the nanoparticles maintain stable at approximately 900° C. for about one hour.

### Embodiment 5

This embodiment provides the anti-icing and anti-frosting performance test of the manganese-zinc ferrite nanoparticle.

Method: A semiconductor refrigeration platform (LTD1-350) is used. The sample is placed on the semiconductor refrigeration platform for a frosting experiment conducted at −8° C. The sample is placed on a magnet generating a magnetic field of 2600 Gauss. The darker region represents a sample coated with the OA+FAS co-modified manganese-zinc ferrite nanoparticle (i.e., magnetic fluid, an experimental sample), the white region represents an uncoated sample (a control sample). Both the experimental and control samples are subjected to a high-humidity, low-temperature environment (−8° C., 99% humidity).

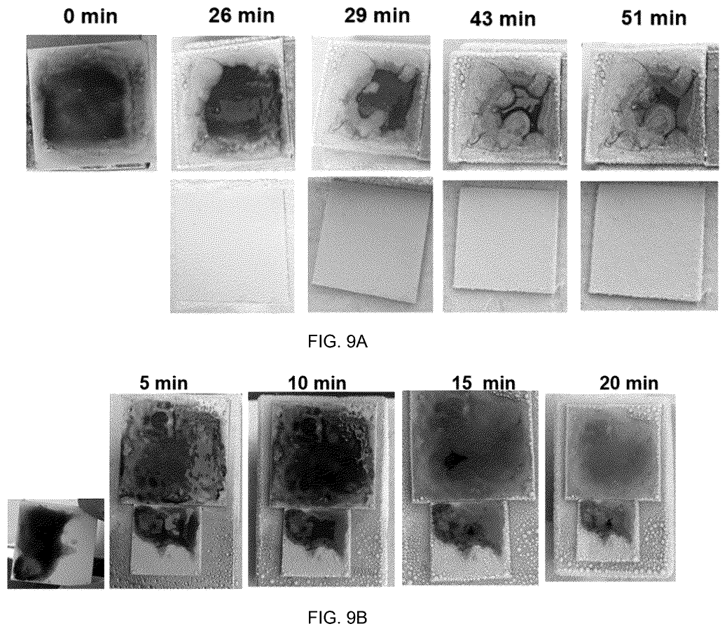

As shown in FIG. 9, the darker (black) region exhibits delayed frosting relative to the white region (where visible frosting occurs within 20 minutes) at different time points. Furthermore, the frost crystals that formed on the rough surface of the experimental sample (with magnetic fluid) are smaller than those observed on the surface of the white region. This demonstrates that the magnetic fluid material prepared in the present invention can effectively prevent frosting.

### Embodiment 6

This embodiment provides the core loss testing of the manganese-zinc ferrite nanoparticle.

Method: A SQUID-VSM magnetic property measurement system (Quantum Design, USA) is used. The procedure is as follows:
(1) Weigh the mass of the magnetic powder sample.
(2) Load the magnetic powder sample into the sample rod and place the sample rod into the measurement chamber.
(3) Flush the chamber with helium gas (default procedure: flush three times), followed by evacuation. (4) Set the temperature range (100 K-400 K) and the magnetic field strength (1.5 T); scan the “signal-position” curve to locate the sample.
(5) Apply a DC or AC magnetic field to the magnetic powder sample to obtain DC (AC) magnetization intensity versus temperature (field strength) curves for the test sample, namely M-H curves. For the M-H curves measured at various temperatures, the value of the magnetic field (H) when magnetization (M) equals 0 is calculated. A large absolute value of H indicates high coercivity, which increases susceptibility to heat generation under alternating magnetic fields at room temperature during power transmission, thereby leading to core loss. Conversely, smaller H values or M-H curves closer to the origin indicate lower coercivity and good paramagnetic behavior, resulting in minimal heat generation and low core loss under alternating magnetic fields at room temperature.

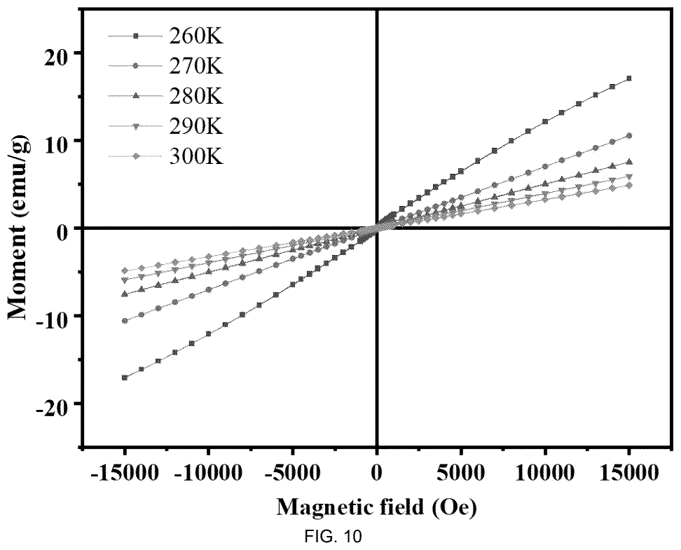

The M-H test of the OA+FAS co-modified manganese-zinc ferrite nanoparticle (molecular formula: (Mn_{0.5}Zn_{0.5}) Fe₂O₄) prepared in Embodiment 1 is performed. As shown in FIG. 10, the coercivity values at 260 K, 270 K, 280 K, 290 K, and 300 K are 0.46 Oe, 0.085 Oe, 0.34 Oe, 0.26 Oe, and 0.025 Oe, respectively, with negligible remanent magnetization (close to 0). Therefore, these results confirms that the OA+FAS co-modified manganese-zinc ferrite nanoparticle (molecular formula: (Mn_{0.5}Zn_{0.5}) Fe₂O₄) prepared in Embodiment 1 is a soft magnetic material and does not cause magnetic hysteresis losses or heat generation under transmission-line operating conditions, making it suitable for anti-icing or anti-frosting applications on transmission lines.

The embodiments of the present invention are described above with reference to the accompanying drawings, but the present invention is not limited to the aforementioned specific embodiments. The aforementioned embodiments are merely illustrative and not limiting. For those of ordinary skill in the art, many forms can be made under the teaching of present invention without departing from the spirit of the present invention and the scope of the claims, all of which shall fall within the protection scope of the present invention.

What is claimed is:

1. An anti-icing and anti-frosting manganese-zinc ferrite nanoparticle, wherein the molecular formula of the manganese-zinc ferrite nanoparticle is (MnₓZn_{y}) Fe₂O₄, wherein X=0.5 and Y=0.5; the manganese-zinc ferrite nanoparticle comprises a tetragonal crystal structure and a particle size range of 100-200 nm; a preparation method for the manganese-zinc ferrite nanoparticle is a hydrothermal method, comprising the following steps:
S01: adding the following materials in parts by weight into purified water and stirring to obtain a reaction solution: 10-40 parts of ferric nitrate, 1-10 parts of manganese nitrate, and 1-15 parts of zinc nitrate; and adjusting pH of the reaction solution to be alkaline;
S02: transferring the reaction solution into a hydrothermal reactor and performing a hydrothermal reaction at a temperature of 180° C. for 12 hours to obtain a first product;
S03: centrifuging the first product, followed by drying, grinding, and annealing to obtain a crude manganese-zinc ferrite nanoparticle product; a method of the annealing comprises heating at a rate of 3-10° C./min to a temperature of 600-1200° C., maintaining the temperature of 600-1200° C. for 4-24 hours, and then cooling to room temperature;
S04: modifying the crude manganese-zinc ferrite nanoparticle product with a 5-25 wt. % oleic acid solution followed by a 3-20 wt. % fluorosilane solution in ethanol, to obtain the anti-icing and anti-frosting manganese-zinc ferrite nanoparticle.

2. The manganese-zinc ferrite nanoparticle according to claim 1, wherein the manganese-zinc ferrite nanoparticle is prepared from the following materials, comprising, in parts by weight: 30-40 parts of ferric nitrate, 5-10 parts of manganese nitrate, and 10-15 parts of zinc nitrate.

3. The manganese-zinc ferrite nanoparticle according to claim 1, wherein the pH of the reaction solution is adjusted to a range of 9-11 in S01.

4. The manganese-zinc ferrite nanoparticle according to claim 1, wherein the method of the annealing in S03 is heating at a rate of 5-10° C./min to a temperature of 900-1000° C., maintaining the temperature of 900-1000° C. for 12-24 hours, and cooling to room temperature.

5. The manganese-zinc ferrite nanoparticle according to claim 1, wherein subjecting the crude manganese-zinc ferrite nanoparticle product to ultrasonic treatment in methanol to obtain a second product, adding the second product to a 5-25 wt. % oleic acid solution followed by a 3-20 wt. % fluorosilane solution in ethanol to obtain a mixture; heating the mixture to remove an unreacted solvent and obtain a third product; and then washing, drying, and collecting the third product via magnetic separation to obtain the anti-icing and anti-frosting manganese-zinc ferrite nanoparticle in S04.

6. An application of the manganese-zinc ferrite nanoparticle according to claim 1 in the preparation of an anti-icing magnetic fluid coating or an anti-frosting magnetic fluid coating for a power transmission conductor.
